(19) United States
(12) Patent Application Publication
(10) Pub. No.: US 2022/0109911 A1
(43) Pub. Date: Apr. 7, 2022

(54) METHOD AND APPARATUS FOR DETERMINING AGGREGATE SENTIMENTS

(71) Applicants: Evan Quisenberry, Ferndale, MI (US); Daphne Lorraine Zargar, Detroit, MI (US); Walter Capers, Highland, MI (US); Brian Betts, Ferndale, MI (US); Sarah Elizabeth Cleveland, Dearborn, MI (US); Octavio Fabbri, Ann Arbor, MI (US)

(72) Inventors: Evan Quisenberry, Ferndale, MI (US); Daphne Lorraine Zargar, Detroit, MI (US); Walter Capers, Highland, MI (US); Brian Betts, Ferndale, MI (US); Sarah Elizabeth Cleveland, Dearborn, MI (US); Octavio Fabbri, Ann Arbor, MI (US)

(73) Assignee: Tanto, LLC, Detroit, MI (US)

(21) Appl. No.: 17/492,117

(22) Filed: Oct. 1, 2021

Related U.S. Application Data
(60) Provisional application No. 63/086,696, filed on Oct. 2, 2020.

(51) Int. Cl. H04N 21/442; H04N 21/44; H04N 21/466; H04N 21/8405

(52) U.S. Cl. CPC H04N 21/44226; H04N 21/44012; H04N 21/8405; H04N 21/44218; H04N 21/4666

(57) ABSTRACT

An example method includes obtaining, from a plurality of audience members that are recipients of media content, sentiment data indicating reactions of the plurality of audience members to the media content. The media content includes at least one of audio and video, and the sentiment data includes commentary from the recipients regarding the media content or physical reactions of the audience members to the media content. At least one aggregate sentiment of the plurality of audience members is determined based on the sentiment data. At least one the following is performed: transmitting an indication of the at least one aggregate sentiment to a computing device, and augmenting the media content to indicate the at least one aggregate sentiment to the audience members.

### RELATED APPLICATIONS

This application claims the benefit of U.S. Provisional Application No. 63/086,696, filed Oct. 2, 2020, the disclosure of which is incorporated by reference herein in its entirety.

### BACKGROUND

This application relates to media content, and more particularly to determining an aggregate sentiment of audience members of media content.

As Internet usage continues to flourish, more and more people consume media content through online interfaces, and react to such content over the Internet as well. In the example of a sporting event, the impact of a full stadium of cheering or jeering spectators may be diminished as spectators move away from live attendance and towards Internet viewing, potentially providing a different experience for in-person and remote viewers.

### SUMMARY OF THE INVENTION

A method according to an example of the present disclosure includes obtaining, from a plurality of audience members that are recipients of media content, sentiment data indicating reactions of the plurality of audience members to the media content. The media content includes at least one of audio and video, and the sentiment data includes commentary from the recipients regarding the media content or physical reactions of the audience members to the media content. At least one aggregate sentiment of the plurality of audience members is determined based on the sentiment data. At least one the following is performed: transmitting an indication of the at least one aggregate sentiment to a computing device, and augmenting the media content to indicate the at least one aggregate sentiment to the audience members.

In a further embodiment of any of the foregoing embodiments, obtaining sentiment data includes obtaining the commentary from a broadcast platform that is a source of the media content for the plurality of audience members.

In a further embodiment of any of the foregoing embodiments, the media content is provided through a broadcast platform, and the obtaining sentiment data includes obtaining, from one or more social networks that are separate from the broadcast platform, a plurality of social media posts associated with the media content. The determining of at least one aggregate sentiment includes determining the at least one aggregate sentiment based on content of the social media posts.

In a further embodiment of any of the foregoing embodiments, determining the at least one aggregate sentiment based on content of the social media posts includes weighting particular ones of the social media posts based on at least one of a quantity of followers of a user that posted the particular social media post, and reactions of other users of the social media network to the particular social media post.

In a further embodiment of any of the foregoing embodiments, obtaining the sentiment data from the one or more social networks includes transmitting a request to the one or more social networks for social media posts associated with the media content. The request includes criteria for identifying the social media posts associated with the media content, and the plurality of social media posts are received based on the request.

In a further embodiment of any of the foregoing embodiments, the request is transmitted on a periodic basis according to a predefined schedule.

In a further embodiment of any of the foregoing embodiments, the method includes detecting that a predefined event has occurred in the performance, and the request is transmitted based on the detecting.

In a further embodiment of any of the foregoing embodiments, detecting that a predefined event has occurred in the media content includes receiving an indication from a content provider that is a source of the media content that the predefined event has occurred.

In a further embodiment of any of the foregoing embodiments, detecting that the predefined event has occurred in the performance includes utilizing a neural network to analyze the media content and detect the predefined event in the media content.

In a further embodiment of any of the foregoing embodiments, determining at least one aggregate sentiment of the plurality of audience members is performed based on presence of at least one of the following in the commentary: ideograms, punctuation, capitalization, hashtags, and non-hashtag keywords.

In a further embodiment of any of the foregoing embodiments, determining the at least one aggregate sentiment of the plurality of audience members includes obtaining images of the audience members physically reacting to the media content, and utilizing a neural network to determine sentiments of the audience members based on the images.

In a further embodiment of any of the foregoing embodiments, the media content includes video, and the augmenting includes adding to the video a graphical depiction of a character that exhibits the at least one aggregate sentiment, or transmitting an instruction to a content provider of the video to add the graphical depiction of the character to the media content.

In a further embodiment of any of the foregoing embodiments, the augmenting includes adding crowd noise to the media content that is indicative of the at least one aggregate sentiment, or transmitting an instruction to a content provider of the broadcast to add the crowd noise to the media content.

In a further embodiment of any of the foregoing embodiments, the broadcast includes a video depiction of a scene, and the augmenting includes modifying the lighting of the scene based on the at least one aggregate sentiment, or transmitting a notification to a content provider of the media content to modify the lighting of the scene based on the at least one aggregate sentiment.

An audience sentiment detection system according to an example of the present disclosure includes one or more processors operatively connected to memory and configured to obtain, from a plurality of audience members that are recipients of media content, sentiment data that indicates reactions of the plurality of audience members to the media content. The media content includes at least one of audio and video, and the sentiment data includes commentary from the recipients regarding the media content or physical reactions of the audience members to the media content. The one or more processors are configured to determine at least one aggregate sentiment of the plurality of audience members based on the sentiment data, and perform at least one of: transmit an indication of the at least one aggregate sentiment to a computing device, and augment the media content to indicate the at least one aggregate sentiment to the audience members.

In a further embodiment of any of the foregoing embodiments, to obtain the sentiment data, the one or more processors are configured to obtain the commentary from a broadcast platform that is a source of the media content for the plurality of audience members.

In a further embodiment of any of the foregoing embodiments, the media content is provided through a broadcast platform, and to obtain the sentiment data, the one or more processors are configured to obtain, from one or more social media networks that are separate from the broadcast platform, a plurality of social media posts associated with the media content. To determine the at least one aggregate sentiment, the one or more processors are configured to determine the at least one aggregate sentiment based on content of the social media posts.

In a further embodiment of any of the foregoing embodiments, to obtain the sentiment data from the one or more social networks, the one or more processors are configured to transmit a request to the one or more social networks for social media posts associated with the performance. The request includes criteria for identifying the social media posts associated with the performance. The one or more processors are configured to transmit the request either on a periodic basis according to a predefined schedule, or based on detection of a predefined event in the performance.

In a further embodiment of any of the foregoing embodiments, the one or more processors are configured to perform the determination of the at least one aggregate sentiment based on the presence of at least one of the following in the commentary: ideograms, punctuation, capitalization, hashtags, and non-hashtag keywords.

In a further embodiment of any of the foregoing embodiments, to augment the media content, the one or more processors are configured to add to the media content a modification based on the at least one aggregate sentiment, or transmit an instruction to a content provider of the media content to add the modification to the media content. The modification includes a graphical depiction of a character that exhibits the at least one aggregate sentiment or crowd noise that is indicative of the at least one aggregate sentiment.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 schematically illustrates an example audience sentiment detection system.

FIG. 2 schematically illustrates an example method that may be performed by the audience sentiment detection system of FIG. 1.

FIG. 3 schematically illustrates an example embodiment of the method of FIG. 2.

FIG. 4 is a table listing a plurality of attributes of example aggregate sentiments.

FIG. 5 illustrates an example chart of a quantity of aggregate sentiments corresponding to a particular polling period for media content.

FIG. 6 depicts a plurality of example avatar images, each associated with a particular sentiment.

FIG. 7 depicts an example comment interface for media content, along with sentiments inferred from individual ones of the comments.

FIG. 8 depicts example media content augmented with one of the avatar images of FIG. 6.

FIG. 9 schematically illustrates an example computing device that may be used in the audience sentiment detection system of FIG. 1.

### DETAILED DESCRIPTION

As described herein, one or more systems and methods for detecting sentiment are provided. The sentiment may be detected from one or more persons, and an output based upon the detected sentiment generated. In one or more embodiments, the output is based on an aggregate sentiment of more than one person. As described herein, sentiment may be gathered from one or more sources, such as social media posts/contributions, verbal utterances, indications of interest, for example, user registrations, geographic locations of the one or more persons, etc.

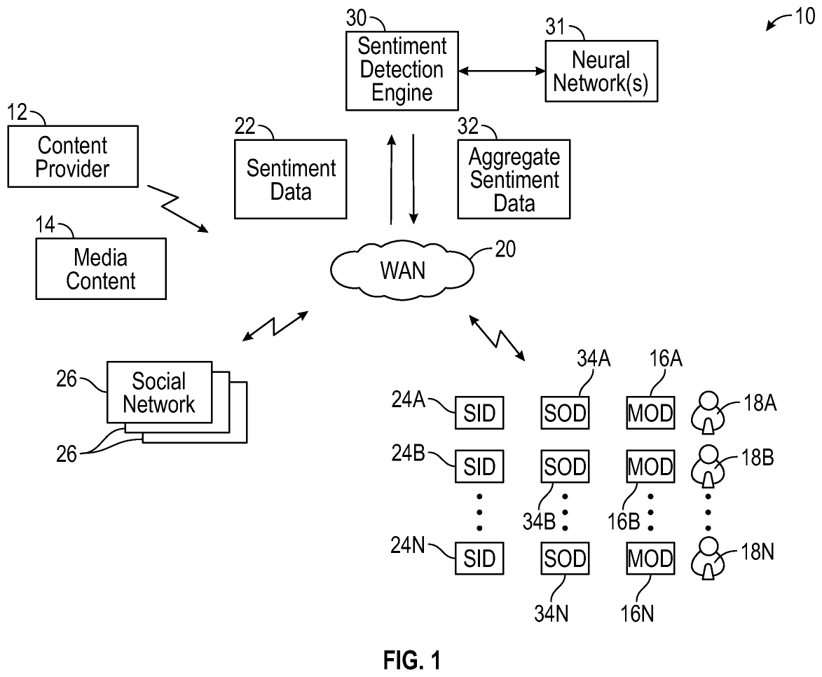

FIG. 1 schematically illustrates an example audience sentiment detection system 10 for detecting an aggregate sentiment of a plurality of audience members 18A-N according to an embodiment of the present disclosure. The audience members 18 receive media content, such as audio and/or video. The media content may depict a performance, such as a sporting event, a concert, a comedy performance, a political rally, and/or a video game playthrough, for example. Other types of content could include advertisement commercials, or any number of other type of media content for which a person may provide sentiment.

In the example of FIG. 1, one or more content provider computing devices 12 transmit media content 14 to a plurality of media output devices (MODs) 16A-N of the plurality of audience members 18. The media content 14 may include audio and/or video of a performance Some examples of the media content 14 may include any of the following:
Video: livestream (World Wide Web) feeds, broadcast feeds, recorded video files, stadium camera feeds, etc. Some example sources include YOUTUBE, TWITCH, FACEBOOK, INSTAGRAM, etc.
Audio: Microphone output, audio (World Wide Web) feeds, recorded audio files, stadium microphone feeds, etc. Some example sources include podcasters, radio stations, music streaming platforms, etc.

As used herein, an “audience member” may include a viewer and/or listener of a video transmission, a listener of an audio transmission, for example. The media content 14 may include video corresponding to any one or combination of a television broadcast, Internet webcast, Internet stream, etc., for example.

The media content 14 is transmitted through a wide area network (WAN) 20, such as the Internet. The MODs 16A-N may include televisions, desktop or laptop computers, mobile computing devices (e.g., smart phones or tablets), network-connected smart speakers (e.g., an Amazon Echo), or radios, for example.

The audience members 18 provide sentiment data 22 regarding the media content 14 through sentiment input devices (SIDs) 24A-N. The SIDs 24A-N are computing devices, such as mobile computing devices, desktop or laptop computers, or the like, which include microphones, cameras or monitors capable of capturing input, or the like. The sentiment data can be provided in a variety of ways, such as social media posts transmitted to social networks 26 (e.g., FACEBOOK, TWITTER, INSTAGRAM). As an example, the sentiment data 22 may be expressed using ideograms (e.g., emojis), ASCII depictions of facial expressions such as smiles and frowns, hash tags (e.g., “#GOTIGERS”), non-hash tag keywords (e.g., profanity), punctuation (e.g., exclamation points), and/or capitalization (e.g., all letters capitalized for an excited sentiment) or any natural language utterance or natural language writing. As an example, if a football game featuring the New England Patriots is being broadcast and a predefined percentage of the audience members 18 are posting “#GOPATS” then that may be indicative of an aggregate sentiment of excitement amongst the plurality of audience members 18.

Of course, although social networks 26 are depicted in FIG. 1 and are described herein as one example source of sentiment data, it is understood that sentiment data may be gathered from other sources in addition to or an alternative to social networks (e.g., non-social network websites and/or other internet-based sources of data).

As used herein, the letter N in a reference numeral (e.g., 18N) indicates a plurality of the component corresponding to that numeral. Thus, there may be dozens, hundreds, thousands, tens of thousands, or millions of audience members 18, for example. Also, although each “N” quantity may be the same in some examples, the quantity does not have to be the same. Thus, even though there are 16N MODs, that does not need to be the same quantity of SIDs 24 or audience members 18. In one embodiment, audience members 18 share MODs 16, for example (e.g., a group of people watching a sporting event on a television in someone's home or at a bar). In the same or another embodiment, audience members 18 share SIDs 24 (e.g., through sentiment-indicating photos recorded by a single SID 24 that are indicate of the sentiment of a plurality of audience members 18).

A sentiment detection engine (SDE) 30 receives the sentiment data 22 from the SIDs 24. The sentiment data may be human readable (e.g., text and emojis) and/or machine readable (e.g., motion detection data, infrared data, etc.).

The SDE 30 repeatedly collects sentiment data 22 during a plurality of polling periods. In one embodiment, the polling periods are conducted periodically (e.g., every minute, 5 minutes, 10 minutes, 15 minutes, or some other interval) and/or in response to detected predefined events in the media content 14. As an example, in a sporting event a predefined event may include a strikeout or homerun (baseball), a touchdown or field goal or quarterback sack (football), a dunk (basketball), etc. As another example, a predefined event for a concert could include an artist emerging onto the stage. Each type of performance (e.g., sporting event, concert, political rally, video gaming live stream, etc.) may have its own unique event signatures, such that different predefined events within the performance would be used to trigger sentiment data collection.

In one or more embodiments, the SDE 30 detects events in a performance by receiving notifications of such events from the one or more content provider computing devices 12 or from another source. In the same or other embodiments, the SDE 30 detects events in the media content 14 using one or more neural networks 31 that are trained with training data indicating predefined events from previous performances.

Periodic polling periods may be useful for assessing general audience sentiment for the media content, and targeted polling that is based on detected events in the media content may be useful for assessing audience member reaction to the specific events. These types of polling may be combined to gauge a general mood of the viewing audience and also audience reactions to specific events.

The SDE 30 analyzes the sentiment data 22 to determine one or more aggregate sentiments expressed by the plurality of audience members 18. In one or more embodiments, this determination includes determining a sentiment expressed by at least a predefined percentage of the audience members 18 as being an aggregate sentiment (e.g., at least 20% or some other predefined percentage). In one or more embodiments, the percentage is set to a low amount (e.g., 2%) so that only statistically insignificant sentiments are excluded. In one or more embodiments, determination of the aggregate sentiment includes determining the X most common sentiments as the aggregate sentiments (e.g., with X being one, two, or some other quantity). In one embodiment, the SDE 30 analyzes and uses the sentiment data 22 from each of the audience members 18 in determining the one or more aggregate sentiments.

The SDE 30 may be configured to account for different cultural interpretations of collected sentiment data (e.g., “bad” means “good” in certain social groups, fans, generations), business and/or marketing goals in the form of statistical discretion (e.g., “only include fan reactions from social media posts originating from the United States of America”). Different geographic areas and/or different users may use different cheers, body movements, and language to indicate the same sentiments. While a younger audience may call something “Bad” (as in “Badass”) to express a positive sentiment, an older audience may be less likely to use such a term to indicate a positive sentiment. The SDE 30 may be configured to account for these differences.

Thus, as described above, in one or more embodiments, the SDE 30 may determine multiple aggregate sentiments. For example, in a sports performance, a particular event such as a turnover may simultaneously inspire an excited reaction from many fans of the team gaining possession of the ball and a frustrated and/or angry reaction from many fans of the team losing possession of the ball.

In one or more embodiments, the SDE 30 utilizes one or more neural networks 31 to determine aggregate sentiments (e.g., by analyzing photos of the audience members 18 and/or text provided by the audience members 18). Thus, there may be multiple neural networks, such as one or more for detection of events in the performance and one or more for sentiment detection based on audience commentary and/or based on audience physical reactions (e.g., hands in the air for excitement, slumped over posture for disappointment, etc.). The neural network(s) 31 may be trained for any one or combination of these analyses.

The SDE 30 transmits aggregate sentiment data (ASD) 32 describing the one or more aggregate sentiments to one or more sentiment output devices (SODs) 34A-N, which then provide an indication of the aggregate sentiment(s) to the audience members 18. In one example, the SDE 30 uses weighting to determine how significantly to represent each aggregate sentiment in the ASD 32. This weighting may be based on how many of the audience members indicate various sentiments and/or who those audience members are. For example, the sentiment data 22 from certain ones of the audience members 18 may be weighted higher than others. In one example, the sentiment data 22 from a list of one or more predefined social media influencers (e.g., with a threshold amount of “followers” on a social media platform) is weighted more significantly than regular audience members with no social media followers, an unknown quantity of social media followers, and/or a quantity of social media followers below the threshold.

The aggregate sentiments may be determined differently for different areas. Consider an example in which two sporting teams are playing against each other, with Team A from City A and Team B from City B. In one such example, the SDE 30 weights the sentiment data 22 from City A more greatly for the ASD 32 for City A, and similarly weights the sentiment data 22 from City B more greatly for the ASD 32 for City B. Thus, the fans of each team would be more likely to receive ASD 32 corresponding to other likeminded viewers (e.g., hear cheers for your home team more significantly than cheers for the opposing team).

The SODs 34 may include televisions, smartphones, tablet computing devices, laptop computing devices, lighting devices (e.g., operable to emit light colors and/or patterns corresponding to various sentiments), network-connected smart speakers, and/or aromatic devices, such as a wax burners and/or network-connected perfume aerosol dispensers configured to emit a particular scent in response to a particular aggregate sentiment (e.g., release a puff of lavender scent every time a particular team scores during a sporting event).

Although depicted separately, the MODs 16, SIDs 24, and/or SODs 34 may be combined into two or one devices for a particular audience member 18 in some embodiments. In one or more embodiments, the MOD 16 and SOD 34 for a particular audience member 18 are both part of a single computing device, such as a television, laptop, tablet, smartphone, etc. that is configured for viewing the media content 14 and posting to social networks. In one or more embodiments, the SID 24, SOD 34, and MOD 16 are all the same device for a particular audience member 18 (e.g., the audience member 18 streams the media content 14 to their smartphone, posts to one of the social networks 26 from the smartphone, and views aggregate sentiment indications as part of the media content 14 stream). Audience members 18 may also share sentiment output devices (SODs) 34 (e.g., if the SOD is a television that is being used to display the media content 14).

In one or more embodiments, the ASD 32 is provided to the content provider computing device(s) 12, which then indicate the aggregate sentiment(s) in the media content 14 through an audio indication (e.g., crowd noise), visual indication (e.g., computer generated facial expressions), or a combination of audio and visual indications.

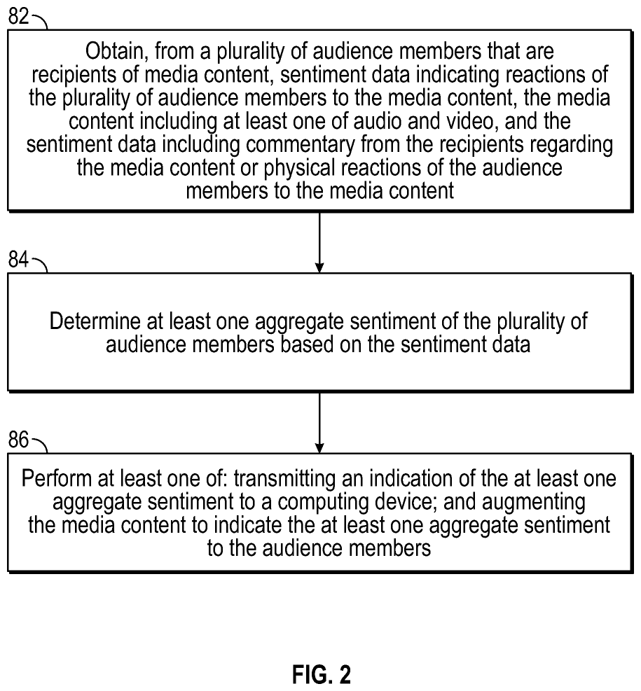

FIG. 2 schematically illustrates a flowchart 80 of an example method that may be performed by the audience sentiment detection system 10 of FIG. 1. Sentiment data is obtained from a plurality of audience members that are recipients of media content (e.g., that are viewers of a broadcast of a performance) (step 82). The sentiment data indicates reactions of the plurality of audience members to the media content, and includes commentary from the recipients regarding the media content or physical reactions of the audience members to the media content. A determination is made of at least one aggregate sentiment of the plurality of audience members based on the sentiment data (step 84). At least one of the following is performed: transmitting an indication of the at least one aggregate sentiment to a computing device (e.g., content provider computing device 12), and augmenting the broadcast to indicate the at least one aggregate sentiment to the audience members (step 86). The method of FIG. 2 may be performed by the content provider computing devices 12, for example.

In one example, the media content is provided as a broadcast through a broadcast platform (e.g., an Internet-based broadcast platform such as YOUTUBE or TWITCH), and obtaining the sentiment data in step 82 includes obtaining commentary from the broadcast platform. This could include comments provided in a comment area associated with the broadcast (e.g., a YOUTUBE comment area). In the same or another example, the determination of the aggregate sentiment is determined based on audience reactions to a comment (e.g., comment “likes” or “upvotes”). In one particular example, comments having more than a threshold amount of audience reactions are weighted more than comments having less than the threshold amount of audience reactions.

In one example, the media content is provided through a broadcast platform (e.g., Internet-based or non-Internet based), and obtaining the sentiment data in step 82 includes obtaining, from one or more social networks that are separate from the broadcast platform, a plurality of social media posts associated with the performance. The determination of the at least one aggregate sentiment in step 84 in this example includes determining the at least one aggregate sentiment based on the social media posts.

In one example, particular ones of the social media posts are weighted based on at least one of a quantity of followers of a user that posted the particular social media post, and reactions of other users of the social media network to the particular social media post. Thus, sentiment data from a social media “influencer” who has a larger number of followers (e.g., with a quantity of followers that exceeds a predefined threshold) may be weighted more than sentiment data from a typical user (e.g., having a quantity of followers that is below a predefined threshold). Alternatively, or in addition, social media posts that have a threshold quantity of reactions can be weighted higher than posts with a quantity of positive reactions that are less than the threshold. In one example, this is only applied to posts having positive reactions (e.g., “likes”, thumbs up reactions, etc.).

In one example, obtaining the sentiment data from the one or more social networks (step 82) includes transmitting a request to the one or more social networks for social media posts associated with the performance, where the request includes criteria for identifying the social media posts associated with the performance. The criteria could include relevant hashtags or keywords for example (e.g., “Super Bowl” or “SUPERBOWL2019”).

The social network requests may be transmitted on a periodic basis according to a predefined schedule (e.g., every 30 seconds, every minute, every 5 minutes, etc.) and/or based on detection of a predefined event in the performance (e.g., a dunk in a basketball game, a field goal setup in a football game, a penalty shot setup in a hockey game, etc.). Different types of events may have different types of predefined events that are relevant to that event. For example, a dunk is unlikely to be relevant to a musical concert, but is likely to be relevant to a basketball game. Similarly, an encore performance by a musical artist is likely to be relevant to a musical concert, but not to an athletic event.

Detection of a predefined event may be based on receiving a notification from a content provider that provides the media content, and/or based on a neural network analysis (performed by the neural network(s) 31) of the media content, for example.

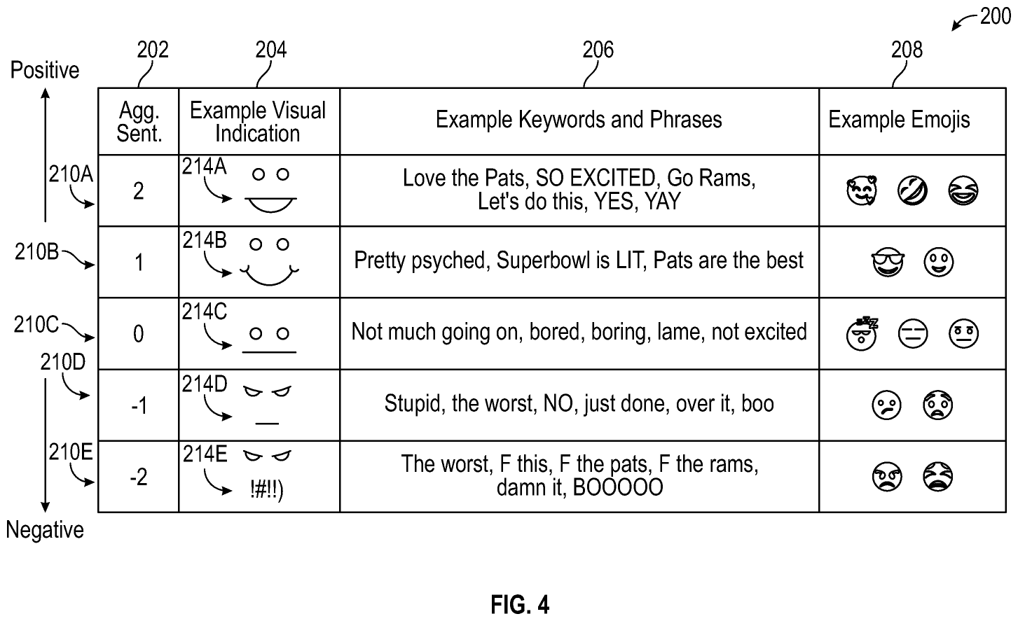

Analysis of audience member commentary may be based on at least one of the following, for example: ideograms (e.g., emojis), punctuation (e.g., all caps social media posts), hashtags, and non-hashtag keywords (e.g., profanity). This is described in more detail in connection with FIG. 4 below.

In one example, determining at least one aggregate sentiment of the plurality of audience members in step 84 includes obtaining images of the audience members physically reacting to the broadcast, and utilizing the neural network(s) 31 to determine sentiments of the audience members based on the images. This could be based on the facial expressions, posture, and/or gestures of the audience members, for example.

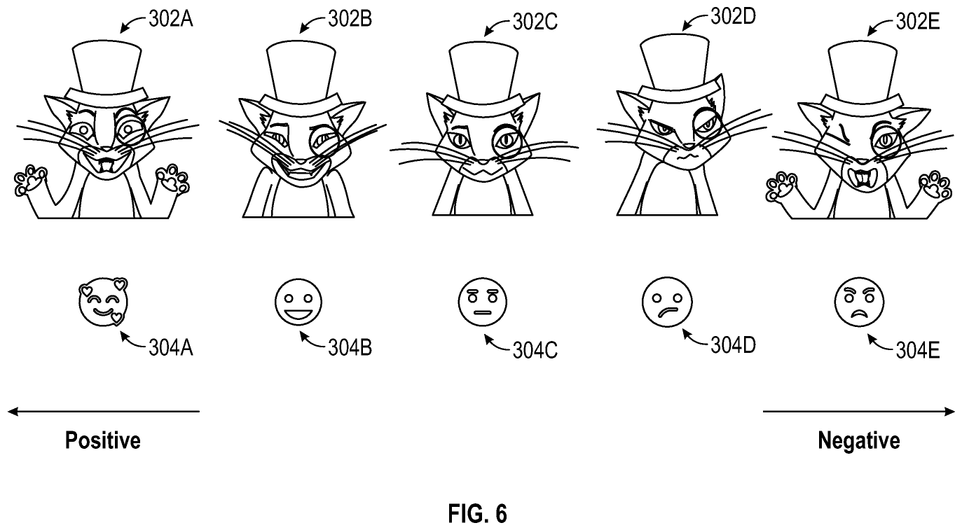

In one example, augmenting the broadcast in step 86 includes adding to the broadcast a graphical depiction of a character that exhibits the at least one aggregate sentiment, or transmitting an instruction to a content provider of the broadcast to add the graphical depiction of the character to the broadcast. This is discussed in greater detail in connection with FIGS. 6-8 below.

In one example, augmenting the broadcast in step 86 includes adding crowd noise to the broadcast that is indicative of the at least one aggregate sentiment, or transmitting an instruction to a content provider of the broadcast to add the crowd noise to the broadcast.

In one example, the broadcast includes a video depiction of a scene, and augmenting the broadcast in step 86 includes modifying the lighting of the scene based on the at least one aggregate sentiment, or transmitting a notification to a content provider of the broadcast to modify the lighting of the scene based on the at least one aggregate sentiment. Thus, if the audience is expressing excited sentiments, lighting could be changed in color or in brightness, for example.

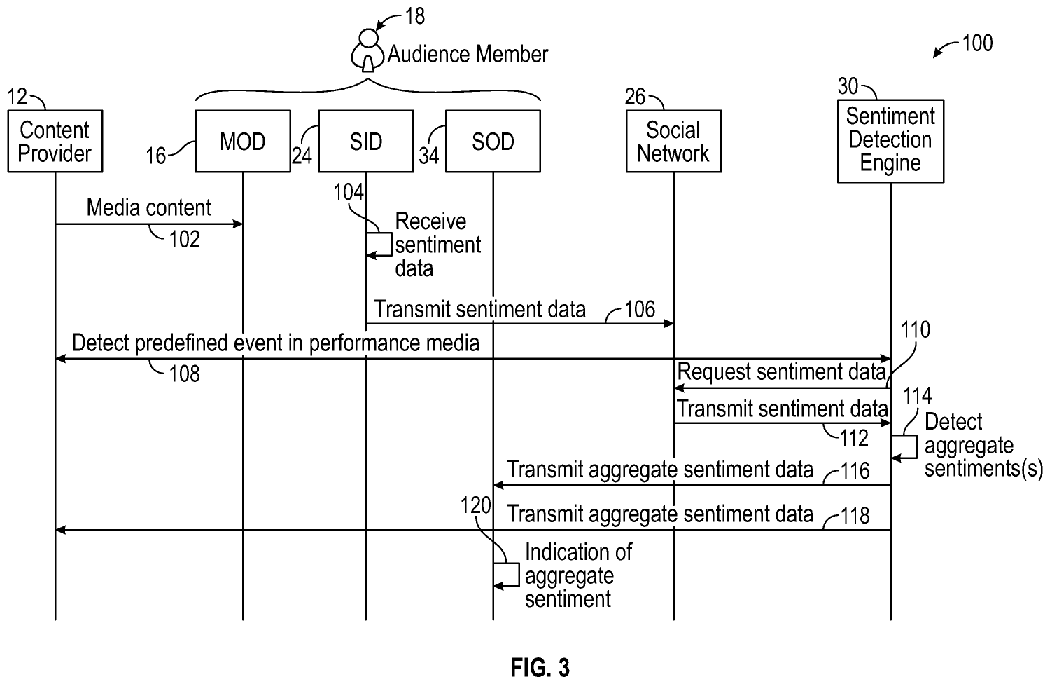

FIG. 3 schematically illustrates an embodiment of the method of FIG. 2. The content provider computing device(s) 12 transmit media content 14 to the respective MODs 16 of a plurality of audience members 18 (one of which is shown in FIG. 2) (step 102). This may be a broadcast and/or a video stream, for example.

The audience member 18 provides sentiment data to their SID 24 (step 104), and in the example of FIG. 3, the SID 24 transmits the sentiment data 22 to the social network 26 (e.g., in the form of a text, image, or video social media post) (step 106). However, it is understood that other embodiments would be possible, such as the SID 24 transmitting the sentiment data directly to the SDE 30 (e.g., through a website or mobile application, which may be a non-social media website or mobile application).

The SDE 30 detects a predefined event in the media content 14 (step 108), and based on detection of that event requests sentiment data 22 from the social network 26 (step 110). Of course, it is understood that this is only an example, and it is understood that the SDE 30 may alternatively or in addition request sentiment data on a periodic basis without step 108 without detection of a predefined event. In one example, the request of step 110 includes one or more descriptors of a performance associated with the performance data (e.g., the word “SuperBowl” and/or a hashtag such as #SUPERBOWL2019).

In one or more embodiments, the SDE 30 “detecting” a predefined event in the media content 14 is based on one or more of the following: the SDE 30 receiving a notification from the content provider or another entity that the event has occurred (e.g., a message from the content provider), and the SDE 30 independently detecting the event from the media content 14 (e.g., based on using one of the neural network(s) 31 to determine whether a predefined event has occurred, such as a dunk in a basketball game, a field goal setup in a football game, a penalty shot setup in a hockey game, etc.).

In one or more embodiments, one or more first neural networks 31 are used for detecting sentiments, and one or more second neural networks 31 that are different from the one or more first neural networks 31 are used for detecting predefined events in the media content 14 corresponding to what is depicted in the media content (e.g., predefined events for a football game, for a basketball game, for a concert, etc.). The SDE 30 associates those detected sentiments and predefined events with each other in order to determine the aggregate sentiment data 32.

In one or more embodiments, the SDE 30 utilizes one or more application programming interfaces (APIs) of the one or more social networks 26 to obtain the sentiment data during a given polling period in step 110.

The social network 26 uses the one more descriptors in the request of step 110 to identify sentiment data associated with the performance, and transmits the sentiment data (e.g., social media posts) to the SDE 30. The SDE 30 receives the requested sentiment data 22 (step 112), and analyzes the sentiment data 22 from the plurality of audience members 18 to determine one or more aggregate sentiments of the plurality of audience members 18 (step 114).

The SDE 30 transmits aggregate sentiment data (ASD) 32 describing the one or more aggregate sentiments to the SOD 34 of the audience members 18 (step 116) and/or transmits the ASD 32 to the computing device(s) 12 of the content provider. Although steps 116 and 118 are both shown in FIG. 3, it is understood that one of the steps may be omitted depending on how the audience sentiment detection system 10 is configured to provide aggregate sentiment data to audience members 18.

An indication of the aggregate sentiment data is presented to the audience member 18 through their sentiment output device 34 (step 120). In one or more embodiments, step 120 may include the content provider adding an indication of the aggregate sentiment to a stream of the media content 14 (e.g., step 118 followed by a transmission from the content provider computing device(s) 12 to the SOD 34 with step 116 skipped).

In one or more embodiments, the SOD 34 outputs an indication of the aggregate sentiment without receiving the ASD 32 from the content provider computing device(s) 12 (e.g., step 116 followed by step 120 with step 118 skipped).

The embodiment of FIG. 2 may be repeated multiple times for a particular media content 14 for a plurality of the polling periods, such that the audience member 18 receives a plurality of sequential indications about the aggregate sentiment. Also, although only one audience member 18 is depicted in FIG. 3, it is understood that the method may be performed for a plurality of audience members 18.

FIG. 4 is a table 200 listing a plurality of attributes of example aggregate sentiments. Although the table 200 includes some language that is specific to a football game between the New England Patriots (e.g., “Love the Pats”) and the Los Angeles Rams (e.g., “Go Rams”), it is understood that these are only examples, and that different language may be used for other teams and other types of media content.

Column 202 indicates an aggregate sentiment on a scale of −2 to +2 with −2 being the most negative, +2 being the most positive, and 0 being approximately neutral.

Column 204 indicates a plurality of example visual indications 214A-E that may be used to express their corresponding aggregative sentiment to audience members 18.

Column 206 indicates examples keywords and phrases that are indicative of the aggregate sentiment for a particular type of media content 14. Column 208 indicates example ideograms that are indicative of an aggregate sentiment. In the example of FIG. 4, the ideograms of column 208 are emojis.

Since human sentiments vary between different types of content (e.g., sentiments for a concert video are likely to differ from those of a comedy show video or sporting event video or political event video), the keywords and phrases of column 206 and/or the ideograms of column 208 and/or any other data in the table 200 may be normalized for the type of content being depicted in the media content 14.

The table 200 includes a plurality of rows 210A-E, each corresponding to a different aggregate sentiment.

Referring to row 210A as an example, the sentiment is a most positive sentiment of +2, includes a most positive indication in column 204, includes positive keywords (e.g., “Love the Pats”, “SO EXCITED”, etc.) in column 206, and includes the most positive emojis in column 208. In the example of “SO EXCITED”, capitalization is indicative of positive sentiment.

In contrast, referring to row 210E as an example, the sentiment is a most negative sentiment of −2, includes a most negative indication in column 204, includes negative keywords (e.g., “The worst”, “damn it”, “BOOOOO”, etc.) in column 206, and includes the most negative emojis in column 208. In the example of “BOOOOO”, capitalization is indicative of a negative sentiment.

As shown in the preceding examples, the use of capitalization can be indicative of either a positive sentiment (“SO EXCITED”) or a negative sentiment “BOOOOO”). Similarly, emoji ideograms can be indicative of a wide range of sentiments, as shown in column 208. Punctuation can also be indicative of sentiment, either positive (e.g., “Love the Pats!!!”) or negative (e.g., “That was a terrible call by the referee!!!”). In item 214E, the punctuation “!#!!)” is used as an example visual indication of profanity. Similar punctuation could also be used as a keyword for detecting sentiment (e.g., “What the heck happened on that play?!?!?”).

It is understood that FIG. 4 is only an example, and that other quantities of aggregate sentiments may be used, other indications of aggregate sentiments may be used (e.g., non-visual audio indications and/or other visual indications), and that other keywords, phrases, and/or ideograms may be used.

The SDE 30 is configured to look for sentiment data that indicates various sentiments. Referring to the example of a social network, in one or more embodiments the SDE 30 determines whether a given posting provides sentiment data for a media content 14 based on sentiment-indicating keywords and/or phrases (e.g., “Love the Pats”, “Superbowl is LIT”, etc.) and/or non-sentiment indicating keywords, such as hashtags (e.g., “#SUPERBOWL2019”) which indicate that the audience member 18 is referencing the media content 14 but alone do not necessarily indicate a sentiment about the media content 14. The SDE 30 may use the non-sentiment indicating keyword(s) from an audience member as criteria to correlate the sentiment-indicating keywords and/or phrases with the media content 14.

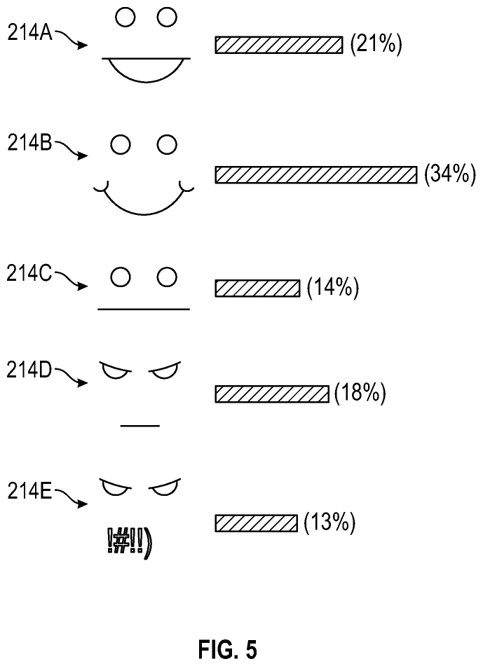

FIG. 5 illustrates an example chart of the quantity of aggregate sentiments from the table 200 of FIG. 4 corresponding to a particular example polling period for the example media content 14. As shown, a +2 sentiment is detected for approximately 21% of the audience members 18, a +1 sentiment is detected for approximately 34% of the audience members 18, a 0 sentiment is detected for approximately 14% of the audience members 18, a −1 sentiment is detected for approximately 18% of the audience members 18, and a −2 sentiment is detected for approximately 13% of the audience members 18.

Based on the quantity of sentiments expressed by the audience members, the SDE 30 determines which aggregate sentiment(s) to present to the audience members 18 via their associated SODs 34 during a particular polling period, as discussed above, and/or determines how to weight those aggregate sentiments when indicating them to the audience members 18.

There are numerous ways that the SOD 34 may be configured to indicate an aggregate sentiment to the audience member 18. These may include the following, for example:
playing crowd noise that represents the aggregate sentiment in conjunction with the media content 14;
displaying one of the visual indications 214 corresponding to the aggregate sentiment in conjunction with the media content 14 (e.g., overlaying the visual indication 214 onto a video stream);
displaying a color corresponding to the aggregate sentiment in conjunction with the media content 14;
overlaying avatars expressing the aggregate sentiment in conjunction with the media content 14 (e.g., on a computer generated audience);
displaying robots whose movements are indicative of the aggregate sentiment; and/or
emitting smells corresponding to the aggregate sentiment from an aromatic device.

These indications may be provided by augmenting (i.e., modifying) the media content 14. In such examples, the SOD 34 and MOD 16 may be the same device. Alternatively, or in addition, these indications may be provided separately from the media content 14.

As used above, the SOD 34 displaying something (e.g., a visual indication 214, a color, an avatar, etc.) may correspond to the SOD 34 overlaying the item onto the video media content 14, or may include the content provider doing the overlaying, such that the aggregate sentiment is part of the media content 14 when it is received at the MOD 16 (e.g., if the SOD 34 and MOD 16 are a single device).

Similarly, the playback of crowd noise may include the SOD 34 overlaying crowd noise onto the media content 14, or the content provider doing the overlaying such that the crowd noise is included in an audio portion of the media content 14 when it is received at the MOD 16 (e.g., if the SOD 34 and MOD 16 are a single device).

In one example, the crowd noise is prerecorded crowd noise (e.g., real or simulated) and the volume of the crowd noise is adjusted to reflect a sentiment in the aggregate sentiment data 32.

In one or more embodiments, the playback of crowd noise includes modulating a carrier wave based on one or more prerecorded sound files of crowd noise or dynamically generated crowd noise files. In one such example, a base sine wave may be generated using programmatic sine wave generation according to equations 1-3 below:

modulator=sin(2*pi*modulator_hz*n samples/sps) (Eq. 1)

envelope=ac*(1.0+ka*modulator) (Eq. 2)

Modulated wave=envelope*carrier wave (Eq. 3)

where: modulator_hz represents a modulation frequency;
n represents a polling frequency at which sentiment data is requested;
sps represents samples per second;
ac represents a coefficient that influences the amplitude and output waveform via an envelope; and
ka represents a coefficient value that may be based on quantitative evaluations of human sentiment data (e.g., the quantity of tweets containing the hashtag “#GoRams” in a 20 second window of time);

The SDE 30 may collect sentiment data from social networks 26 (e.g., using APIs) and convert the sentiment data into integer arrays matching .wav file or other data formats. A stereo wave file, when converted to binary values, may be read as a numerical matrix with two rows and N numbers of columns. Modulation waves from the envelope influence each set of binary values—the degree in how much influence may be resolved by using the (ka) value which tunes sensitivity. In one example, if a row of data from the .wav file was removed, one may get a single channel, which may enable a football game with Home vs. Away teams to use Channel A and Channel B binary data to create different crowd noises layered in the same audio file. When played in a stadium, it may be presented in such a manner that it sounds like there are two distinct “sides” to the cheering.

The SDE 30 generates a base sine wave using equation 1 above. In acoustic math, the term “envelope” refers to that waveform that is drawn from uppermost and lowermost extremes. The SDE 30 uses the sentiment data to attenuate the modulator waveform through its amplitude control (ac) and amplitude sensitivity (ka) with equation 2 above.

In one example, the SDE 30 retrieves a source sound file (e.g., a .wav file) to create a carrier wave, and deconstructs the carrier wave into integer arrays from its binary package. These integers of the carrier wave are modulated individually on a one-to-one basis with channel data (e.g., channels of stereo audio files). The SDE 30 creates a modulated wave using equation 3 above. The SDE 30 uses the resulting single array of modulated integer values to encode a sound file. The encoded sound file is then shared with the SODs 34.

The source sound file may be a broadcast audio/video file, a pre-recorded crowd file, or a digitally generated and entirely artificial crowd noise, for example. The SDE 30 in one example is configured to modulate the source sound file (e.g., so that a sound file of a ten second clip of steady cheering is modified based on the ASD 32 to sound as if the cheering increases in the middle of the 10 second clip based on the number of Tweets containing the hashtag “GoRams”). In one example, the found file (e.g., of steady crowd noise) may be repeatedly (e.g., continuously) played back to the SODs 34 to have a steady crowd noise which is then modified based on the ASD 32 to produce different, unique output crowd noises.

In one or more embodiments, the SDE 30 indicates multiple aggregate sentiments differently based on how many audience members 18 express the sentiment. Referring to FIG. 5, as an example, the +1 sentiment corresponding to indication 214B is expressed by more audience members than the +2 sentiment corresponding to indication 214B. Correspondingly, the SDE 30 may weight and indicate the +1 sentiment more prominently than the +2 sentiment (e.g., a louder sound for the +1 sentiment than the +2 sentiment and/or a more prominent visual indication for the +1 sentiment than the +2 sentiment, etc.).

The sentiment detection examples discussed above (e.g., in relation to step 114) have focused largely on receiving text and ideograms from social media posts. In some embodiments, sentiment data may be obtained from photographs and/or videos of audience members 18 from social media posts.

In one such example, the SDE 30 is configured to use one of the neural network(s) 31 to recognize human sentiment from photographs (e.g., standalone images and/or still frames from a video). This may be based on facial expression (e.g., excitement, anger, happiness, frustration), posture (e.g., slumped over), arm position (e.g., above head if cheering and/or excited), etc. The sentiment-detecting neural network 31 may be trained using training data corresponding to previous human images where sentiment is expressed (e.g., crowd images from previous sporting events, concerts, etc.). In the same or another example, sentiment may be detected based on audio from a video from an audience member (e.g., detecting chants, cheers, whistles, boos, shouts, etc.).

FIG. 6 depicts a plurality of example avatar images 302A-E, each associated with a particular sentiment. Avatar image 302A corresponds to row 210A of FIG. 4 and to a most positive sentiment. Avatar image 302B corresponds to row 210B of FIG. 4 and to a moderately positive sentiment. Avatar image 302C corresponds to row 210C of Figure and to a neutral sentiment. Avatar image 302D corresponds to row 210D of FIG. 4 to and to a moderately negative sentiment. Avatar image 302E corresponds to row 210E of FIG. 4 and to a most negative sentiment. A series of emoji ideograms 304A-E are also shown in FIG. 6, each associated with a particular one of the avatar images 302A-E. The emoji ideograms 304A-E are similar to the example ones shown in FIG. 5.

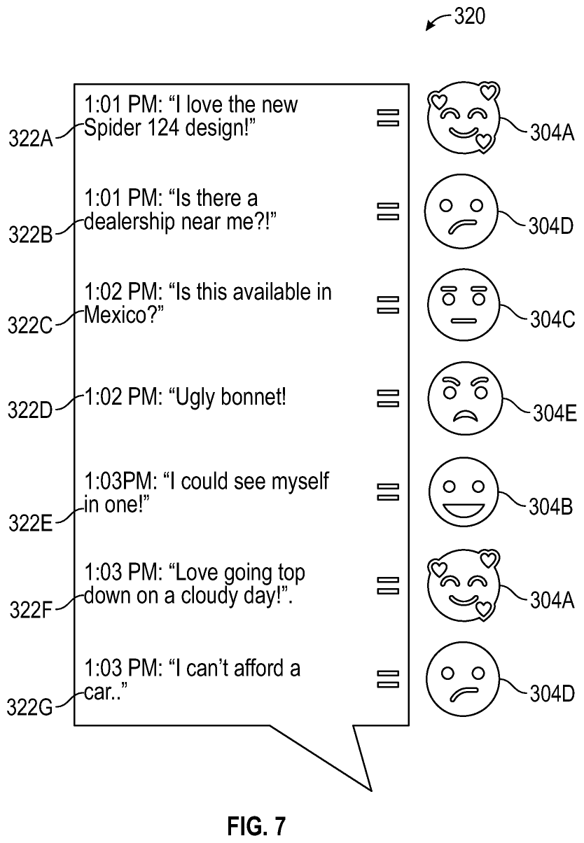

FIG. 7 depicts an example media content comment interface 320, which includes a plurality of example comments 322A-G. From each of the comments 322, the SDE 30 determines a corresponding sentiment, each represented by the emoji ideograms 304A-E of FIG. 6.

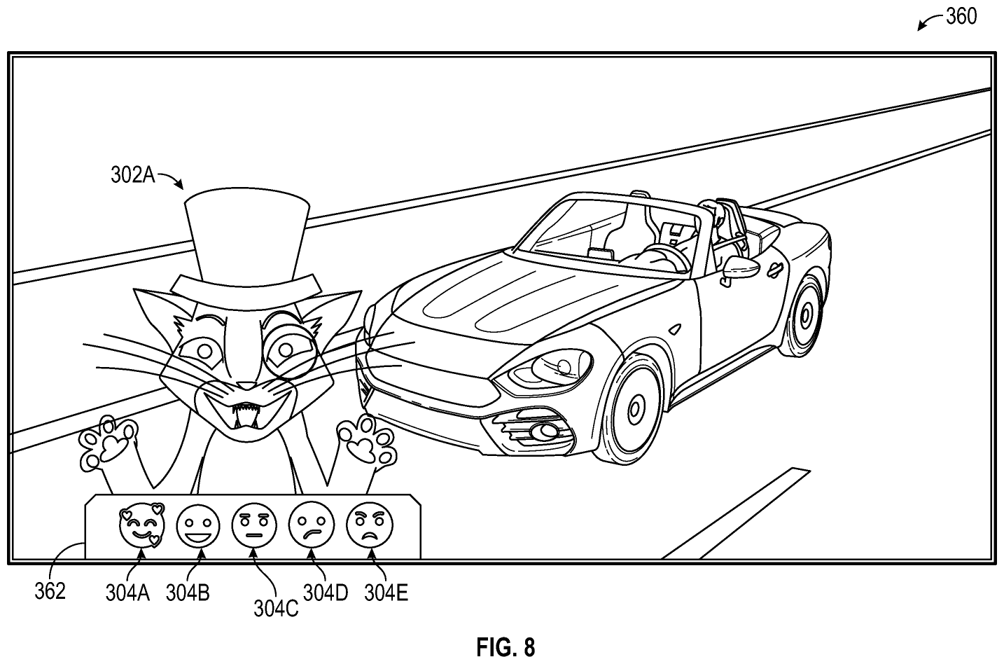

FIG. 8 depicts example media content 360 which is a video frame augmented with avatar image 302A of FIG. 6. In the example of FIG. 8, the avatar image that is displayed is indicative of an aggregate sentiment of an audience of the video. A comment area 362 is provided for viewers to click on an emoji ideogram 304 corresponding to their current sentiment. This may be used in addition to or as an alternative to the text-based comment interface 320 of FIG. 7.

In the example of FIG. 8, the particular avatar image 302A that is shown overlaid onto the video and is selected based on current audience sentiment. Throughout the video, the avatar may adjusted to other ones of the avatar images 302 based on changes in the audience sentiment. In one example, the SDE 30 tracks changes in aggregate sentiment throughout the timeline of a particular piece of media content, and then provides a summary of those changes to a content provider. This may be useful, for example, in gauging audience reaction to television show pilots, movies, commercials, etc.

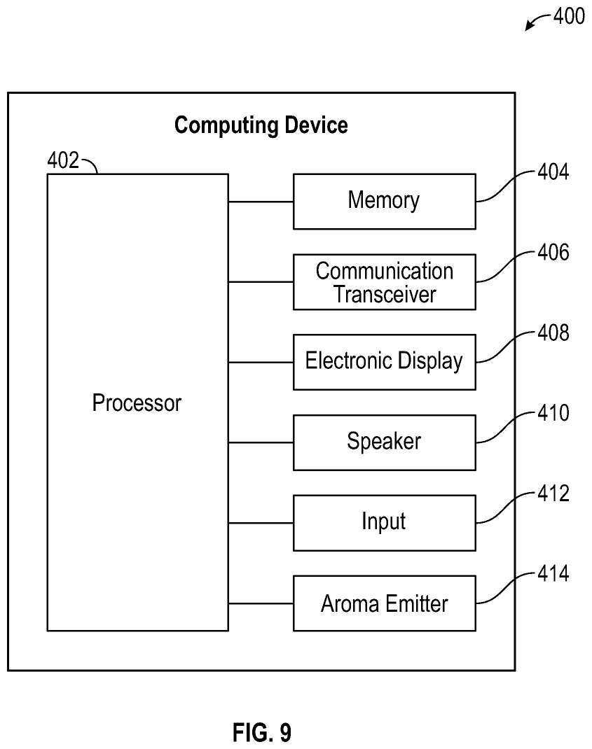

FIG. 9 schematically illustrates an example computing device 400 that may be used in the audience sentiment detection system of FIG. 1 as a server (e.g., for content provider computing device(s) 12, a social network 26 server, a non-social network server that stores media indicating sentiments (e.g., webserver), a server hosting the sentiment detection engine 30) and/or an or audience member 18 device (e.g., MOD 16, SID 24, and/or SOD 34).

The computing device 400 includes a processor 402 operatively connected to memory 404, a communication transceiver 406, and optionally an electronic display 408, speaker 410, input device 412, and/or aroma emitter 414.

The processor 402 includes processing circuitry to perform one or more of the steps of described herein (e.g., of the flowcharts 80, 100). The processor 402 may include one or more microprocessors, microcontrollers, application specific integrated circuits (ASICs), or the like, for example.

The memory 404 may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 404 may incorporate electronic, magnetic, optical, and/or other types of storage media. The memory 404 may also have a distributed architecture, where various components are situated remotely from one another, but may be accessed by the processor 402. The memory 404 stores instructions that configure the processor 402 to perform the one or more steps described above. In one or more embodiments, the memory 404 stores the neural network(s) 31.

The communication transceiver 406 is configured to facilitate communication between the computing device 400 and other computing devices over the WAN 20. The communication transceiver 406 may include a wired transceiver and/or a wireless transceiver (e.g., configured to use WiFi, or a cellular communication standard such as LTE, GSM, etc.).

In one or more embodiments, the electronic display 408, if included, is configured for displaying one or more of the following to the audience member 18: the media content 14, social media content from social networks 26, and a lighting indication of aggregate sentiment. The lighting indication of aggregate sentiment may include displaying light colors and/or patterns on an electronic display such as an array of LEDs (e.g., an LED light strip), a liquid crystal display (LCD), etc.

In one or more embodiments, the speaker 410, if included, is configured to play audio of the media content 14 and/or crowd noise that is based on aggregate sentiment data from the SDE 30.

In one or more embodiments, the input device 412, if included, includes a keyboard, mouse, touchscreen, and/or touchpad for accepting audience member input (e.g., social media posts).

The aroma emitter 414, if included, is likely to only be part of the SOD 34.

Although embodiments in which the audience members 18 view the media content 14 as received through the WAN 20 are discussed above, the audience sentiment detection system 10 may also be used for live audiences. For example, sentiment data may be obtained based on a live audience (e.g., based on crowd noise, crowd motion, and/or crowd temperature), one or more aggregate sentiments may be determined, and aggregate sentiment data may be indicated to the live audience through a large in-stadium display (e.g., a “Jumbotron”) or speaker (e.g., stadium loudspeaker) and/or to remote audience members not present in the live audience (e.g., those far enough from the performance that they cannot see and/or hear the crowd noise) so that the live audience reactions may be more significantly provided to the remote audience.

In one example, the audience sentiment detection system 10 uses data such as crowd motion and/or crowd temperature to assess the accuracy of live audience sentiment data. For example, if audience noise increases beyond a threshold to indicate a positive sentiment, the SDE 30 may verify whether the audience is also moving because movement may be expected for the positive sentiment. If such movement is not detected, the SDE 30 may reduce a magnitude of the positive sentiment, as the lack of movement may be evidence of a false positive detection of crowd noise.

For viewers of performances, such as concerts, sporting events, and political rallies, crowd participation may provide a significant part of the viewing experience. For example, during a sporting event, crowd cheering and other reactions may contribute to a sense of excitement. If one is a spectator, one's emotional reaction to an event may be heightened based on the reactions of other spectators (e.g., through group cheers). Performers, such as athletes and musicians, are known to enjoy and possibly exhibit improved performance based on crowd enthusiasm. In the prior art, when events are broadcasted for remote viewing without a live audience, viewer and performer enthusiasm may be diminished. As described above, the audience sentiment detection system 10 may be used to determine and indicate an aggregate sentiment of an audience even if those audience members are viewing a performance separately from each other over the WAN 20 instead of viewing the performance together in a stadium or other venue, thereby simulating a live viewing experience for audience members not viewing the event live in person.

Although example embodiments have been disclosed, a worker of ordinary skill in art would recognize that certain modifications would come within the scope of this disclosure. For that reason, the following claims should be studied to determine the scope and content of this disclosure.

What is claimed is:

1. A method comprising:
obtaining, from a plurality of audience members that are recipients of media content, sentiment data indicating reactions of the plurality of audience members to the media content, the media content including at least one of audio and video, and the sentiment data including commentary from the recipients regarding the media content or physical reactions of the audience members to the media content;
determining at least one aggregate sentiment of the plurality of audience members based on the sentiment data; and
performing at least one of:
transmitting an indication of the at least one aggregate sentiment to a computing device; and
augmenting the media content to indicate the at least one aggregate sentiment to the audience members.

2. The method of claim 1, wherein:
said obtaining sentiment data includes obtaining the commentary from a broadcast platform that is a source of the media content for the plurality of audience members.

3. The method of claim 1, wherein:
the media content is provided through a broadcast platform;
said obtaining sentiment data includes obtaining, from one or more social networks that are separate from the broadcast platform, a plurality of social media posts associated with the media content; and
said determining at least one aggregate sentiment includes determining the at least one aggregate sentiment based on content of the social media posts.

4. The method of claim 3, wherein said determining the at least one aggregate sentiment based on content of the social media posts comprises:
weighting particular ones of social media posts based on at least one of a quantity of followers of a user that posted the particular social media post, and reactions of other users of the social media network to the particular social media post.

5. The method of claim 3, wherein said obtaining the sentiment data from the one or more social networks comprises:
transmitting a request to the one or more social networks for social media posts associated with the media content, the request including criteria for identifying the social media posts associated with the media content; and
receiving the plurality of social media posts based on the request.

6. The method of claim 5, wherein said transmitting a request is performed on a periodic basis according to a predefined schedule.

7. The method of claim 5, comprising:
detecting that a predefined event has occurred in the media content;
wherein said transmitting a request is performed based on the detecting.

8. The method of claim 7, wherein said detecting that a predefined event has occurred in the media content comprises receiving an indication from a content provider that is a source of the media content that the predefined event has occurred.

9. The method of claim 7, wherein said detecting that the predefined event has occurred in the media content comprises utilizing a neural network to analyze the media content and detect the predefined event in the media content.

10. The method of claim 1, wherein said determining at least one aggregate sentiment of the plurality of audience members is performed based on presence of at least one of the following in the commentary: ideograms, punctuation, capitalization, hashtags, and non-hashtag keywords.

11. The method of claim 1, wherein said determining at least one aggregate sentiment of the plurality of audience members comprises:
obtaining images of the audience members physically reacting to the media content; and
utilizing a neural network to determine sentiments of the audience members based on the images.

12. The method of claim 1, wherein the media content includes video, and said augmenting comprises:
adding to the video a graphical depiction of a character that exhibits the at least one aggregate sentiment; or
transmitting an instruction to a content provider of the media content to add the graphical depiction of the character to the media content.

13. The method of claim 1, wherein the media content depicts a performance and said augmenting comprises:
adding crowd noise to the media content that is indicative of the at least one aggregate sentiment; or
transmitting an instruction to a content provider of the media content to add the crowd noise to the media content.

14. The method of claim 1, wherein the media content includes a video depiction of a scene, and said augmenting comprises:
modifying the lighting of the scene based on the at least one aggregate sentiment; or
transmitting a notification to a content provider of the media content to modify the lighting of the scene based on the at least one aggregate sentiment.

15. An audience sentiment detection system, comprising:
one or more processors operatively connected to memory, and configured to:
obtain, from a plurality of audience members that are recipients of media content, sentiment data indicating reactions of the plurality of audience members to the media content, the media content including at least one of audio and video, and the sentiment data including commentary from the recipients regarding the media content or physical reactions of the audience members to the media content;
determine at least one aggregate sentiment of the plurality of audience members based on the sentiment data; and
perform at least one of:
transmit an indication of the at least one aggregate sentiment to a computing device; and
augment the media content to indicate the at least one aggregate sentiment to the audience members.

16. The audience sentiment detection system of claim 15, wherein:
to obtain the sentiment data, the one or more processors are configured to obtain the commentary from a broadcast platform that is a source of the media content for the plurality of audience members.

17. The audience sentiment detection system of claim 15, wherein:
the media content is provided through a broadcast platform;
to obtain the sentiment data, the one or more processors are configured to obtain, from one or more social networks that are separate from the broadcast platform, a plurality of social media posts associated with the media content; and
to determine the at least one aggregate sentiment, the one or more processors are configured to determine the at least one aggregate sentiment based on content of the social media posts.

18. The audience sentiment detection system of claim 17, wherein to obtain the sentiment data from the one or more social networks, the one or more processors are configured to:
transmit a request to the one or more social networks for social media posts associated with the media content, the request including criteria for identifying the social media posts associated with the performance;
wherein the one or more processors are configured to transmit the request on a periodic basis according to a predefined schedule, or based on detection of a predefined event in the media content.

19. The audience sentiment detection system of claim 15, wherein the one or more processors are configured to perform the determination of the at least one aggregate sentiment based on the presence of at least one of the following in the commentary: ideograms, punctuation, capitalization, hashtags, and non-hashtag keywords.

20. The audience sentiment detection system of claim 15, wherein to augment the media content, the one or more processors are configured to:
add to the media content a modification based on the at least one aggregate sentiment; or
transmit an instruction to a content provider of the media content to add the modification to the media content;
wherein the modification comprises a graphical depiction of a character that exhibits the at least one aggregate sentiment or crowd noise that is indicative of the at least one aggregate sentiment.
